(19) United States
(12) Patent Application Publication
(10) Pub. No.: US 2005/0226338 A1
(43) Pub. Date: Oct. 13, 2005

(54) Camera theft detection system

(75) Inventors: Lance Weston, East Northport, NY (US); Piotr Romanczyk, Huntington Station, NY (US); Tony Li, Roslyn Heights, NY (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 10/818,413

(22) Filed: Apr. 5, 2004

(51) Int. Cl. H04N 7/12

(52) U.S. Cl. 375/240.25; 348/143

(57) ABSTRACT

Image data from a video surveillance camera is moved from a volatile memory such as a circular buffer to a non-volatile memory such as a flash memory when a loss of signal from the camera is detected. The loss of signal may occur when an intruder disables the system such as by cutting a cable, by vandalizing the camera so that it no longer can transmit image data, or removing the camera altogether. The loss of signal is detected by determining whether a signal portion such as a start of active video code, end of active video code, or horizontal or vertical blanking interval, is present on a communication path of the camera. The system ensures that an image of the intruder is captured and stored before the system is disabled. Analog signals from the camera may be digitized for storage.

### BACKGROUND OF THE INVENTION

1. Field of Invention

The invention relates generally to a method and system for storing data from a video surveillance camera when a signal from the camera is lost, such as due to power loss or vandalism.

2. Description of Related Art

Video surveillance cameras have become increasingly popular due to security concerns in businesses, homes and public spaces. Such cameras typically provide analog or digital images via a cable to a secure location where the images are monitored by personnel and/or stored in memory for subsequent viewing. However, this approach requires a substantial amount of data to be stored. To address this concern, schemes have been developed to store data only when a triggering event has occurred. For example, a motion detector or door or window detector may be coupled to a video surveillance system so that images are recorded only when the motion of an intruder is detected. This approach is problematic since the motion detector may provide false alarms when persons who are not intruders set off the motion detector. Moreover, the intruder may disable the system such as by cutting the cable, vandalizing the camera so that it no longer can transmit image data, or removing the camera altogether. In such cases, an image of the intruder may not be captured and stored before the system is disabled.

### BRIEF SUMMARY OF THE INVENTION

To overcome these and other deficiencies in the prior art, the present invention describes a method and system for storing buffered data from a video surveillance camera when a loss of signal from the camera is detected.

In one aspect of the invention, a method for storing image data from at least one camera includes: (a) monitoring a communication path of the at least one camera to determine whether a signal of the at least one camera is present on the communication path, (b) receiving image data from the signal of the at least one camera via the communication path when the signal of the at least one camera is present on the communication path, (c) storing the received image data in a first storage location, and (d) copying the received image data that is stored in the first storage location to a second storage location when the monitoring determines that the signal of the at least one camera is no longer present on the communication path.

Related apparatuses are also presented.

### BRIEF DESCRIPTION OF THE DRAWINGS

These and other features, benefits and advantages of the present invention will become apparent by reference to the following text and figures, with like reference numbers referring to like structures across the views, wherein:

FIG. 1 illustrates an overview of an apparatus for storing data from a camera;

FIG. 2 illustrates an overview of a method for storing data from a camera; and

FIG. 3 illustrates a more detailed view of a method for storing data from a camera.

### DETAILED DESCRIPTION OF THE INVENTION

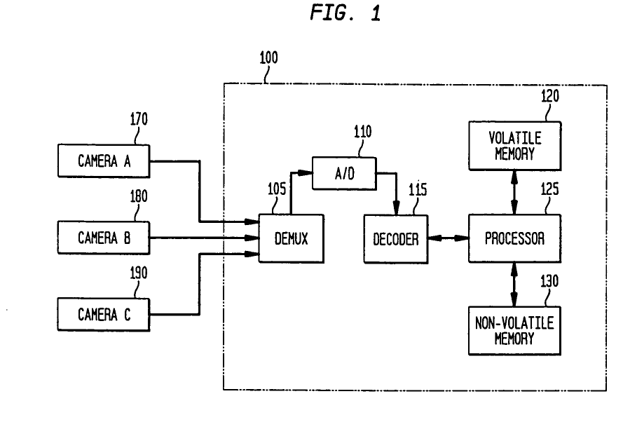

FIG. 1 illustrates an overview of an apparatus for storing data from a camera. Generally, the invention is suitable for use with any type of camera, including those that provide analog or digital data signals. For example, analog signals may be provided according to a conventional television format such as NTSC, PAL or SECAM. Moreover, interlaced or non-interlaced scanning may be used. Digital cameras, such as those using CCDs or CMOS sensors, may provide static images according to a format such as JPEG. Various type of cameras used for surveillance are known in the art. The invention is also suitable for use with one or multiple cameras.

The data storage apparatus 100 is configured for the case where image data from multiple cameras is received in analog form. Multiple cameras, denoted in an example as camera A (170), camera B (180) and camera C (190) are provided. Each of the cameras 170, 180 and 190 communicates with the data storage apparatus 100 via respective communication paths 172, 182 and 192, such as cables. Wireless paths may also be used. Typically, the cameras are positioned around a location to be monitored, such as the interior or exterior of a business. The cameras are mounted to a wall or ceiling and a cable is run from each camera to the data storage apparatus 100, which may be in a secure location such as a locked office in the business. Separate wires are typically also run to the camera from a power supply to power the cameras.

In one possible approach suitable for use with analog cameras, the cameras 170, 180 and 190 continuously send data signals to the data storage apparatus 100. The data storage apparatus 100 includes a demultiplexer (demux) 105 that reads one of the signals at a time in a round robin manner. The demux 105 is not needed if there is only one camera. The signal that is being read is digitized at an analog-to-digital (A/D) converter 110 and decoded at a decoder 115. As an example, the decoder 115 may use the Philips Semiconductor SAA7111A Enhanced Video Input Processor (EVIP) and SAA7114 PAL/NTSC/SECAM video decoder with adaptive PAL/NTSC comb filter, VBI-data slicer and high performance scaler. The decoder 115 provides digitized images from the analog signal as a series of static frames or snapshots. The digitized images may be provided as a CCIR656 bit stream, for instance. The analog signals from the different cameras may be processed in turn to obtain digital snapshot images at a fixed interval for each camera such as every second. Each snapshot image is derived from a frame or field of the analog signal.

The processor 125 interacts with the decoder 115 to store the snapshot images in a volatile memory 120 such as a circular SDRAM buffer. To reduce costs, the volatile memory 120 has a capacity that is sufficient to store a limited number of frames, e.g., up to sixty frames total, or twenty frames, from each of the three cameras. When the volatile memory 120 becomes filled with image data, the older frames are removed while the newer frames are stored, in a first-in, first out manner. Thus, assuming there is a one second interval between frames, for instance, there is a twenty-second snapshot history stored in the volatile memory for each camera.

In accordance with the invention, the data storage apparatus 100 detects when the signal from a camera is no longer present on the respective communication path. This may be achieved in various ways. For example, the processor 125 may detect whether a specified portion of the camera's signal is present on the respective communication path by detecting whether a specified code is output from the decoder 115. The code may identify the end of active video (EAV), start of active video (SAV), or a horizontal or vertical blanking interval (HSYNC or VSYNC, respectively), for instance: In the CCIR 656 standard, for example, each line begins with an EAV code which indicates the end of active video for the previous line, a blanking interval, and an SAV code which indicates the start of active video for the current line, followed by the line of active video. EAV and SAV codes have a fixed format, including a 3-byte preamble of 0×FF, 0×00, 0×00 followed by the SAV or EAV code byte. It is also possible to detect other signal portions, such as color burst codes, when color images are used.

The processor 125 detects the signal portion for each camera to confirm that the associated signal is present on the associated communication path. If the signal portion cannot be detected, the processor 125 initiates a copy or transfer of the image data stored in the volatile memory 120 to a non-volatile memory 130, such as a flash memory. In one approach, when multiple cameras are used, the image data from each camera is transferred when the signal from only one camera is lost. In another approach, only the image data from each camera whose signal is lost is transferred. The image data associated with a particular camera may be identified by meta data associated with the image data.

The non-volatile memory 130 provides a permanent storage of the currently buffered image data so the image data can subsequently be reviewed. If the buffered image data was not transferred to a permanent storage, the circular buffer 120 would continue to store blank or null images in place of the existing valid images until the buffer was eventually filled with useless blank images. The approach of the invention thus allows review of the area imaged by a camera for a period of time preceding the loss of the camera's signal, which could be caused, e.g., by an intruder or vandal cutting the cable used for the communication path or otherwise disabling the camera so that it no longer transmits a valid signal on the communication path to the data storage apparatus 100. For instance, an image of the intruder or vandal is likely to be stored as the person approach the camera to disable it. The person can then be more easily identified and apprehended.

Note also that the data storage apparatus 100 may communicate image data via a network such as the Internet or an intranet. For example, the non-volatile memory 130 may be located remotely from the data storage apparatus 100, such as at a central location that is monitored by personnel. When a camera's signal is lost, the central location is notified via the network and the image data is communicated to the central location. An alarm message can also be communicated to the central location. This approach is advantageous since image data from different locations can be monitored centrally.

In a configuration where the cameras provide digital images to the data storage apparatus 100, the A/D converter 110 is not needed. Such digital data may be provided by the cameras in the CCIR656 format, for instance.

The processor 125 may include a memory as a program storage device for storing software instructions that are executed to achieve the functionality described herein, including detecting the signal portions from the cameras and controlling the storage of the image data.

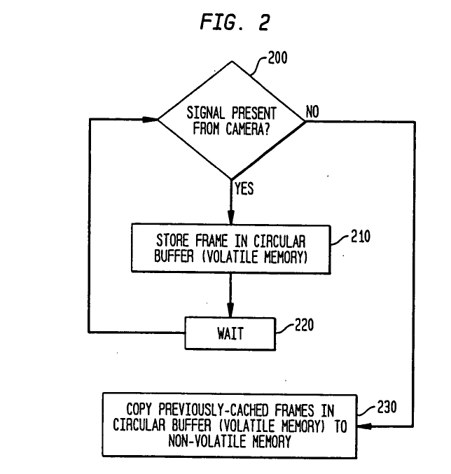

FIG. 2 illustrates an overview of a method for storing data from a camera. At block 200, a determination is made as to whether a signal is present from a camera on the associated communication path. This may involve determining whether a signal portion such as an SAV or EAV code is present, as discussed above, for instance. If the signal is present, an image from the signal, such as a frame, is stored in a volatile memory such as a circular buffer. After a waiting period, e.g., one second, at block 220, the step of block 200 is repeated to again determine whether the signal is still present on the communication path. When the signal is no longer present, processing proceeds at block 230. Specifically, the previously-cached frames in the circular buffer are copied to a non-volatile memory. Note that the steps shown may be repeated for each camera when there are multiple cameras.

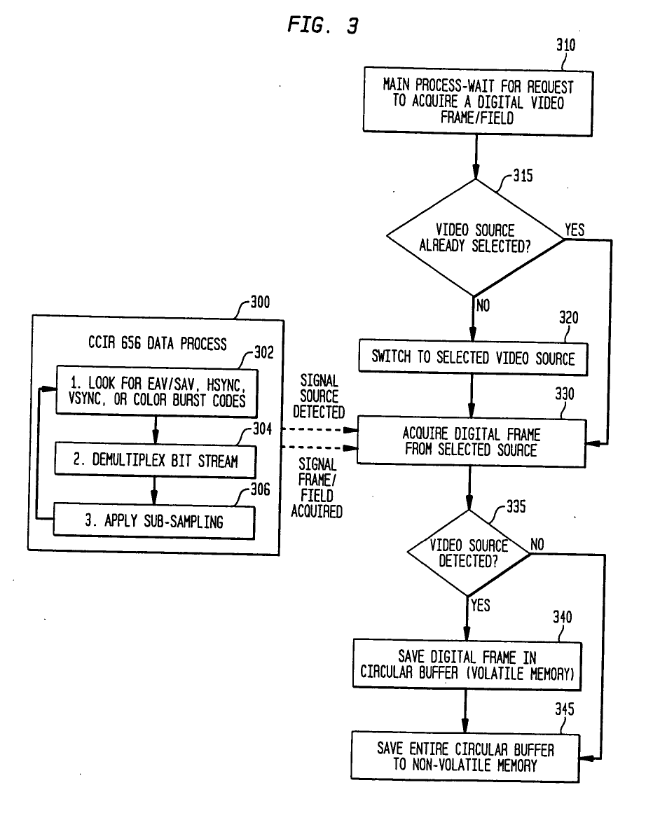

FIG. 3 illustrates a more detailed view of a method for storing data from a camera. Block 300 denotes a data process that may involve processing data in the CCIR 656 data format, for instance. At block 302, the processor 125 looks for a portion of the camera's signal, such as an EAV/SAV code, HSYNC, VSYNC or color burst, in the bit stream that is output from the video decoder 115. At block 304, the bit stream is demultiplexed to recover separate Y, U and V data components, which are stored in the circular buffer 120 in planar format. At block 306, a sub-sampling algorithm is applied to achieve a 4:2:2 planar format. Optionally, the data is scaled to Common Intermediate Format (CIF) video size. Note that signaling of the SAV or EAV to the DSPCPU, e.g., processor 125, may be performed directly from the video decoder (e.g., the SAA7114). The data process at block 300 provides information including whether a signal source is detected, and whether a signal frame/field is acquired.

Starting at block 310, a main process or task runs. Such a task may run for each camera. The task waits for a request to acquire a digital video frame/field. At block 315, a determination is made as to whether a video source, e.g., a particular camera, is already selected. If a video source is already selected, processing proceeds at block 330, where a digital frame is acquired from the selected source. At block 335, a determination is made as to whether the video source is detected. If the video source is detected, a digital frame from the video source is saved in the circular buffer at block 340. The task may subsequently be repeated at block 310. If the video source is not detected at block 335, the entire contents of the circular buffer are saved to the non-volatile memory at block 345.

If the video source has not been selected at block 315, the process switches to the selected video source at block 320, and a digital frame is acquired from the selected source at block 330. Processing then proceeds at block 335 as discussed above.

Note that the steps regarding selecting a particular video source are not need when there is only one video source.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

1. A method for storing image data from at least one camera, comprising:
monitoring a communication path of the at least one camera to determine whether a signal of the at least one camera is present on the communication path;
receiving image data from the signal of the at least one camera via the communication path when the signal of the at least one camera is present on the communication path;
storing the received image data in a first storage location; and
copying the received image data that is stored in the first storage location to a second storage location when the monitoring determines that the signal of the at least one camera is no longer present on the communication path.

2. The method of claim 1, wherein:
the storing the received image data in the first storage location comprises storing the received image data in a circular buffer.

3. The method of claim 1, wherein:
the receiving image data comprises receiving successive image frames.

4. The method of claim 1, wherein:
the storing the received image data in the first storage location comprises storing the received image data in a volatile memory.

5. The method of claim 4, wherein:
the copying the received image data comprises copying the received image data that is stored in the volatile memory to a non-volatile memory.

6. The method of claim 1, wherein:
the monitoring the communication path of the at least one camera to determine whether the signal of the at least one camera is present comprises determining whether a portion of the signal is present on the communication path.

7. The method of claim 6, wherein the determining whether the portion of the signal is present on the communication path comprises determining whether at least one of a start of active video identifier and an end of active video identifier is present on the communication path.

8. The method of claim 6, wherein the determining whether the portion of the signal is present on the communication path comprises determining whether at least one of a horizontal blanking interval and a vertical blanking interval is present on the communication path.

9. The method of claim 1, wherein:
the monitoring the communication path comprises monitoring respective communication paths of a plurality of respective cameras to determine whether respective signals of the respective cameras are present on the respective communication paths;
the receiving image data comprises receiving respective image data from the respective signals of the respective cameras via the respective communication paths when the respective signals of the respective cameras are present on the respective communication paths;
the storing the received image data comprises storing the respective received image data in the first storage location; and
when the monitoring determines that the respective signal of one of the respective cameras is no longer present on the respective communication path, the copying the received image data comprises copying the respective received image data of the one of the respective cameras that is stored in the first storage location to the second storage location.

10. The method of claim 1, wherein:
the monitoring the communication path comprises monitoring respective communication paths of a plurality of respective cameras to determine whether respective signals of the respective cameras are present on the respective communication paths;
the receiving image data comprises receiving respective image data from the respective signals of the respective cameras via the respective communication paths when the respective signals of the respective cameras are present on the respective communication paths;
the storing the received image data comprises storing the respective received image data in the first storage location; and
when the monitoring determines that the respective signal of one of the respective cameras is no longer present on the respective communication path, the copying the received image data comprises copying the respective received image data of each of the respective cameras that is stored in the first storage location to the second storage location.

11. An apparatus for storing image data from at least one camera, comprising:
means for monitoring a communication path of the at least one camera to determine whether a signal of the at least one camera is present on the communication path;
means for receiving image data from the signal of the at least one camera via the communication path when the signal of the at least one camera is present on the communication path;
a first storage location for storing the received image data; and
means for copying the received image data that is stored in the first storage location to a second storage location when the means for monitoring determines that the signal of the at least one camera is no longer present on the communication path.

12. The apparatus of claim 11, wherein:
the first storage location comprises a circular buffer.

13. The apparatus of claim 11, wherein:
the first storage location comprises a volatile memory.

14. The apparatus of claim 13, wherein:
the second storage location comprises a non-volatile memory.

15. An apparatus for storing image data from at least one camera, comprising:
an analog-to-digital converter coupled to a communication path of the at least one camera for digitizing an analog signal from the at least one camera to provide a digitized signal when the analog signal of the at least one camera is present on the communication path;
a video decoder coupled to the analog-to-digital converter for decoding the digitized signal to provide decoded data;
a processor coupled to the video decoder for detecting a code in the decoded data;
a first storage location for storing the decoded data when the processor detects the code in the decoded data; and
a second storage location;
wherein the decoded data stored in the first storage location is copied to the second storage location when the processor no longer detects the code in the decoded data.

16. The apparatus of claim 15, wherein:
the first storage location comprises a circular buffer.

17. The apparatus of claim 15, wherein:
the first storage location comprises a volatile memory.

18. The apparatus of claim 17, wherein:
the second storage location comprises a non-volatile memory.

19. The apparatus of claim 15, wherein:
the code that the processor detects in the decoded data comprises at least one of a start of active video identifier and an end of active video identifier.

20. The apparatus of claim 15, wherein:
the code that the processor detects in the decoded data comprises at least one of a horizontal blanking interval identifier and a vertical blanking interval identifier.
